(19) United States
(12) Patent Application Publication
(10) Pub. No.: US 2003/0090616 A1
(43) Pub. Date: May 15, 2003

(54) Method of and apparatus for producing liquid crystal display unit

(76) Inventors: Yoshihiro Hirakawa, Kagoshima (JP); Kouji Komaki, Kagoshima (JP); Hirofumi Kakebayashi, Kagoshima (JP); Nobuhiro Deguchi, Kumamoto (JP); Seigo Nakano, Kumamoto (JP); Noboru Kawabata, Kagoshima (JP); Yoshihiro Mizuguchi, Kumamoto (JP)

Correspondence Address: ROBERT DEPKE, HOLLAND + KNIGHT, 55 W. MONROE, CHICAGO, IL, 60603, US

(21) Appl. No.: 10/253,091

(22) Filed: Sep. 24, 2002

(30) Foreign Application Priority Data
Sep. 27, 2001 (JP) JP2001-297952

(51) Int. Cl. G02F 1/13

(52) U.S. Cl. 349/187

(57) ABSTRACT

Disclosed is a method of producing a liquid crystal display unit, which is capable of shortening, at the time of adhesively bonding and fixing a transparent substrate to a liquid crystal panel, curing time by eliminating any heating treatment, thereby preventing degradation of the display quality and also improving the productivity. The production method is performed by bringing a transparent substrate into close-contact with a liquid crystal panel with a light-curing resin put therebetween, to form an assembly, and irradiating the assembly with ultraviolet light having a wavelength of 340 nm or more, to cure the light-curing resin for a short time. At this time, ultraviolet light having a wavelength ranging from 240 to 450 nm is emitted from an ultraviolet lamp, and an ultraviolet light component having a wavelength of less than 340 nm is shielded by a sharp cut filter. Since the sharp cut filter shields light having a wavelength of less than 340 nm, which is liable to exert adverse effect on components of the liquid crystal panel such as thin film transistors, liquid crystal molecules, and adhesive, it is possible to cure the light-curing resin without any damage to the components of the liquid crystal panel, and hence to prevent the display quality from being degraded.

### BACKGROUND OF THE INVENTION

The present invention relates to a method of and an apparatus for producing a liquid crystal display unit used for a projection type display unit such as a projector or a projection television.

To form specific images, projectors have been provided with liquid crystal display units for modulating light emitted from the projectors. Such a liquid crystal display unit includes a liquid crystal panel, parting plates, and the like mounted in an outer frame mounted to a projector main body provided with a liquid source and the like. In this liquid crystal display unit, to prevent the display quality of projection images from being degraded due to adhesion of damages and dust on each of outer surfaces of the liquid crystal panel close to a focus plane, another transparent substrate is adhesively bonded overall to the outer surface of the liquid crystal panel by means of a transparent adhesive.

Such a liquid crystal display unit is generally produced by dropping a transparent adhesive on a central portion of an inner surface of a transparent substrate and one outer surface of a liquid crystal panel is superimposed on the inner surface of the transparent substrate, whereby the inner surface of the transparent substrate is overall adhesively bonded to the outer surface of the liquid crystal panel. As such a production method, there is known a method of adhesively bonding a transparent substrate to a liquid crystal panel by using a transparent adhesive having a property capable of keeping flowability after curing, and thermally curing the adhesive for several hours (for example, disclosed in Japanese Patent Laid-open No. 2000-193943), or a method of adhesively bonding a transparent substrate to a liquid crystal panel by using a transparent adhesive having a property capable of keeping flowability after curing, and curing the adhesive at room temperature (for example, Japanese Patent Laid-open No. 2000-66575).

Each of these methods, however, has problems that since it takes a lot of time to cure the transparent adhesive, the productivity is poor, and that since the transparent adhesive of a type in which the flowability is kept after curing is used, bubbles in the adhesive may be moved or enlarged during operation of the liquid crystal display unit, to degrade the display quality.

In particular, the former method of thermally curing the adhesive has a further problem that the heating treatment for solidifying the adhesive may cause stress in the liquid crystal panel, the transparent substrate, and an outer frame, to structurally deform each of parts of the liquid crystal display unit, thereby tending to cause a quality failure such as a variation in gap width of a liquid crystal layer.

### SUMMARY OF THE INVENTION

An object of the present invention is to provide a method of and apparatus for producing a liquid crystal display unit, which are capable of shortening, at the time of adhesively bonding and fixing a transparent substrate to a liquid crystal panel, curing time by eliminating any heating treatment, thereby preventing degradation of the display quality and also improving the productivity.

To achieve the above object, according to a first aspect of the present invention, there is provided a method of producing a liquid crystal display unit including a liquid crystal panel and a transparent substrate adhesively bonded and fixed to an outer surface of the liquid crystal panel. The method includes the steps of bringing the transparent substrate in close-contact with the liquid crystal panel with a light-curing resin put therebetween, and irradiating the light-curing resin with light having a wavelength of 320 nm or more to cure the light-curing resin, thereby adhesively bonding and fixing the transparent substrate to the liquid crystal panel.

With this configuration, since the light-curing resin is cured for a short time by irradiating the light-curing resin with light, the transparent substrate can be easily adhesively bonded and fixed to the liquid crystal panel for a short time, and further, since the light having a wavelength of 320 nm or more does not exert any adverse effect on components of the liquid crystal panel such as thin film transistors and liquid crystal molecules, the display quality of the liquid crystal panel can be prevented from being degraded.

To achieve the above object, according to a second aspect of the present invention, there is provided an apparatus for producing a liquid crystal display unit including a liquid crystal panel and a transparent substrate adhesively bonded and fixed to an outer surface of the liquid crystal panel. The apparatus includes means for irradiating a light-curing resin interposed between the liquid crystal panel and the transparent substrate with light having a wavelength of 320 nm or more.

With this configuration, since the production apparatus has the means for irradiating the light-curing resin with the light having a wavelength of 320 nm or more, it is possible to cure the light-curing resin for a short time and hence to easily adhesively bond and fix the transparent substrate to the liquid crystal panel for a short time, and also to cure the light-curing resin without exerting any adverse effect on components of the liquid crystal panel such as thin film transistors and liquid crystal molecules and hence to prevent the display quality of the liquid crystal panel from being degraded.

The present invention has the following effects:

Since a thermosetting resin or a room temperature setting resin is changed to a light-curing resin, it is possible to significantly shorten the curing time from several hours to several seconds, and hence to significantly improve the productivity.

Since a light-curing resin is cured by irradiating the resin with light having a wavelength of 320 nm or more, it is possible to cure the resin without exerting adverse effect on components of the liquid crystal panel such as thin film transistors, liquid crystal molecules, and adhesive, more concretely, without giving any damage to the components of the liquid crystal panel, and hence to prevent the display quality of the liquid crystal display unit from being degraded.

Since the adhesive is solidified without any heating treatment, it is possible to eliminate occurrence of stress in the outer frame, liquid crystal panel, the transparent substrates, and the like due to thermal expansion, and hence to eliminate the deformation of each of parts of the liquid crystal display unit. This makes it possible to prevent a variation in gap width of the liquid crystal layer, and hence to improve the display quality.

Since a thermosetting resin or a room-temperature setting resin having a flowability is changed into a light-curing resin having no flowability, it is possible to eliminate occurrence of an inconvenience that bubbles between the liquid crystal panel and the transparent substrate are moved or enlarged during operation of the liquid crystal display unit, and hence to prevent the display quality from being degraded.

### BRIEF DESCRIPTION OF THE DRAWINGS

Other features and advantages of the present invention will become more apparent from the following detailed description taken in connection with the accompanying drawings, in which:

FIG. 1 is an exploded view in perspective of a liquid crystal display unit according to one embodiment of the present invention;

FIG. 2 is a sectional view of a stacked structure of the liquid crystal display unit shown in FIG. 1;

FIGS. 3A to 3C are side views illustrating a procedure of adhesively bonding and fixing a transparent substrate to a liquid crystal panel of the liquid crystal display unit shown in FIG. 1; and

FIG. 4 is a schematic configuration view of an ultraviolet irradiation apparatus.

### DETAILED DESCRIPTION OF THE PREFERRED EMBODIMENT

Hereinafter, one preferred embodiment of the present invention will be described in detail with reference to the drawings.

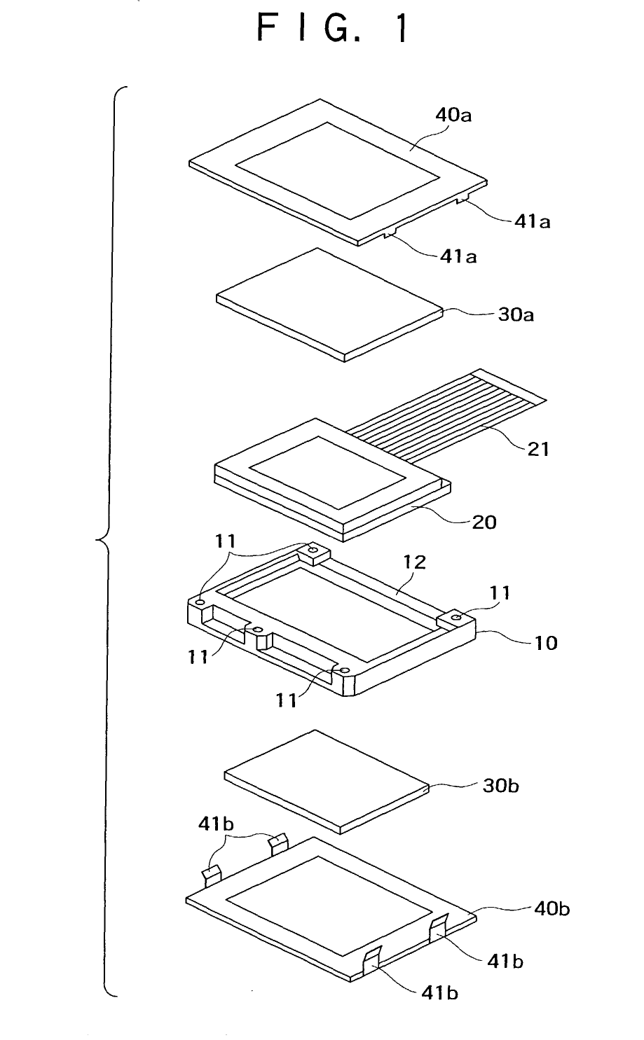

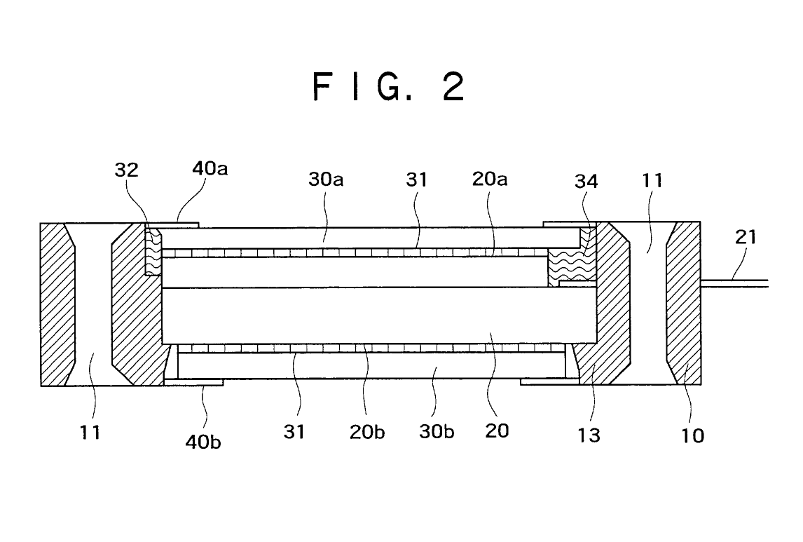

FIG. 1 is an exploded view in perspective of a liquid crystal display unit according to one embodiment of the present invention, and FIG. 2 is a sectional view showing a stacked structure of the liquid crystal display unit shown in FIG. 1.

The liquid crystal display unit according to this embodiment includes an outer frame 10, a liquid crystal panel 20, transparent substrates 30a and 30b, and parting plates 40a and 40b. Light emitted from a light source provided in a projector main body (not shown) is made incident on the liquid crystal panel 20. The incident light is modulated by drive of liquid crystal in the liquid crystal panel 20, and the modulated light is emerged from the liquid crystal panel 20.

The outer frame 10 provided for mounting the liquid crystal display unit to the projector main body is formed into a square shape. The liquid crystal panel 20 and the transparent substrates 30a and 30b, each of which is formed into a square shape, are housed in the outer frame 10, and the parting plates 40a and 40b are mounted on both sides of the outer frame 10.

A plurality of insertion holes 11 through which mounting screws for mounting the outer frame 10 to the projector main body are to be inserted are formed in an outer peripheral portion of the outer frame 10. A cutout portion 12 for leading a flat cable 21 connected to the liquid crystal panel 20 to the outside is formed in one side of the outer frame 10.

The liquid crystal panel 20 is formed by superimposing a counter substrate to a thin film transistor (TFT) substrate with a gap held therebetween and sealing liquid crystal in the gap. In the liquid crystal panel 20, each liquid crystal pixel is controlled by the TFT, to modulate light emitted from the light source thereto. The flat cable 21 is connected to one side of the liquid crystal panel 20.

The liquid crystal panel 20 is adhesively bonded and fixed in the outer frame 10 by making use of a positioning stepped portion 13 provided on an inner side portion of the outer frame 10.

According to this embodiment, as a first adhesive (not shown) for adhesively bonding and fixing the liquid crystal panel 20 to the outer frame 10, there is used a light-curing resin represented by an ultraviolet-curing resin. The first adhesive is cured by irradiating the first adhesive with ultraviolet light, to fix the liquid crystal panel 20 to the outer frame 10.

The ultraviolet-curing resin is exemplified by a modified acrylate resin, for example, produced by Henkel Japan Ltd. Loctite Division under the trade name of “Loctite”. It is to be noted that upon irradiation of the first adhesive with ultraviolet light, the liquid crystal panel 20 portion is covered with a mask for allowing only the adhesive portion to be irradiated with ultraviolet light.

The transparent substrates 30a and 30b are adhesively bonded and fixed on both surfaces on the incident and emergence sides of the liquid crystal panel 20.

According to this embodiment, as a light-curing resin for adhesively bonding and fixing the transparent substrates 30a and 30b to both the sides of the liquid crystal panel 20, there is used a second adhesive 31. The second adhesive 31 is cured by irradiating the second adhesive 31 with light having a specific intensity. With the use of such a second adhesive 31, the transparent substrates 30a and 30b can be fixed to both the sides of the liquid crystal panel 20 without heating. The light-curing resin is exemplified by a modified polyether resin, for example, produced by DENKI KAGAKU KOGYO KABUSHIKI KAISHA under the trade name of “Hardloc OP”.

According to this embodiment, an RTV (Room Temperature Vulcanizing) type silicon resin is poured as a third adhesive 32 in a gap between the incident side transparent substrate 30a and the outer frame 10 and is solidified. It is to be noted that the gap is not necessarily filled with the third adhesive 32. The parting plates 40a and 40b are provided for defining a display region of the liquid crystal display unit. The parting plates 40a and 40b are fixed to the outer frame 10 by fitting a plurality of locking claws 41a of the parting plate 40a and a plurality of locking claws 41b of the parting plate 40b in the corresponding engagement portions (not shown) formed in inner portions of the outer frame 10.

A method of producing the liquid crystal display unit having the above configuration will be described below.

The liquid crystal panel 20 is first adhesively bonded and fixed to the outer frame 10 by coating the inner portion of the outer frame 10 with the first adhesive which is exemplified by an ultraviolet-curing resin as described above, and mounting the liquid crystal panel 20 in the inner portion of the outer frame 10. In this case, the liquid crystal panel 20 is positioned by the positioning stepped portion 13 formed on the inner side portion of the outer frame 10. The flat cable 21 of the liquid crystal panel 20 is placed in the cutout portion 12 of the outer frame 10 and is led to the outside.

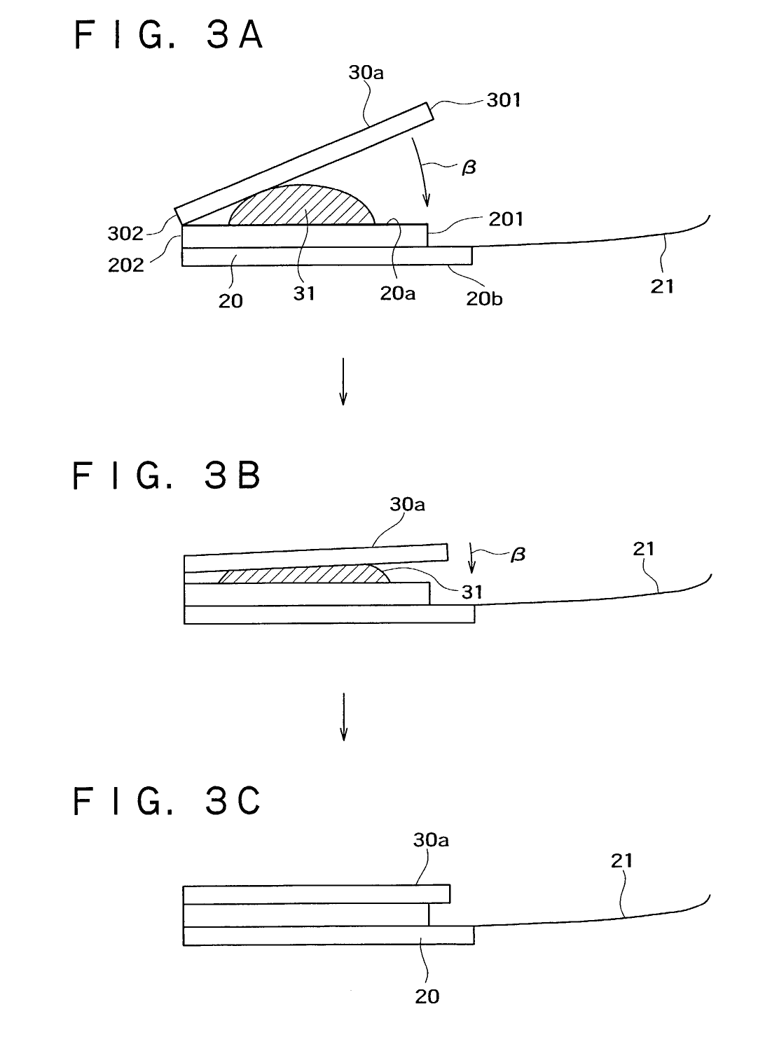

The transparent substrate 30a is then adhesively bonded and fixed to the surface, on the incident side or counter substrate side, of the liquid crystal panel 20. FIGS. 3A to 3C are side views showing a procedure of adhesively bonding and fixing the transparent substrate 30a to the incident side surface of the liquid crystal panel 20. It is to be noted that in these figures, the outer frame 10 is omitted. In this mounting work, as described above, a light-curing resin is used as the second adhesive 31.

Referring to FIG. 3A, the second adhesive 31 is placed in the form of an approximately dome shape on a surface 20a (counter substrate side surface in the example shown in the figure) to be bonded to the transparent substrate of the liquid crystal panel 20, and the transparent substrate 30a is disposed in such a manner as to be tilted from the counter substrate side surface 20a at a specific tilt angle of 30 to 40°. To be more specific, in the example shown in FIG. 3A, a second side 302 of the transparent substrate 30a is aligned to a second side 202, opposed to a first side 201 provided with the flat cable 21, of the liquid crystal panel 20, and a first side 301 of the transparent 30a is disposed in such a manner as to be vertically apart from the liquid crystal panel 20.

The first side 301 of the transparent substrate 30a is gradually turned in a direction where it becomes close to the liquid crystal panel 20 side, as shown by an arrow β in FIGS. 3A and 3B. As a result, the second adhesive 31 placed on the counter substrate side surface 20a of the liquid crystal panel 20 is gradually pushed out to the flat cable 21 side, to be crushed in a thin film shape, so that as shown in FIG. 3C, the transparent substrate 30a is adhesively bonded to the liquid crystal panel 20 with the thin-film shaped second adhesive 31 interposed therebetween.

After the transparent substrate 30a is thus adhesively bonded to the counter substrate side surface 20a of the liquid crystal panel 20, the transparent substrate 30b is similarly adhesively bonded to the TFT substrate side surface 20b of the liquid crystal panel 20 via the thin-film shaped second adhesive 31.

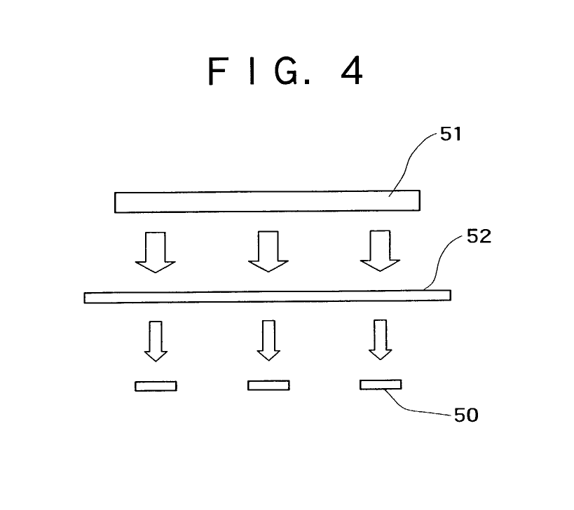

To solidify the second adhesive 31, an assembly 50 of the outer frame 10, the liquid crystal 20, and the transparent substrates 30a and 30b, which are adhesively bonded to each other, is put in an ultraviolet irradiation apparatus shown in FIG. 4, followed by light irradiation. FIG. 4 shows a schematic configuration of the ultraviolet irradiation apparatus.

In the ultraviolet irradiation apparatus shown in FIG. 4, the assembly 50 is irradiated with light (ultraviolet light), having a wavelength of 240 to 450 nm and a light intensity of 40 to 60 mW/cm², emitted from an ultraviolet (UV) lamp 51 as a light source for 20 to 40 seconds via a sharp cut filter 52. The sharp cut filter 52 shields light having a wavelength of less than 340 nm and allows light having a wavelength of 340 nm or more to pass therethrough. By irradiating the assembly 50 with light having a wavelength of 340 nm or more in the ultraviolet irradiation apparatus, the second adhesive 31 between the liquid crystal panel 20 and each of the transparent substrates 30a and 30b is cured, to fix each of the transparent substrates 30a and 30b to the liquid crystal panel 20.

After the second adhesive 31 is solidified, the third adhesive 32, which is exemplified by an RTV type silicon resin as described above, is poured in the gap between the incident side transparent substrate 30a and the outer frame 10 and is solidified. Thereafter, the parting plates 40a and 40b are mounted to both the sides of the outer frame 10.

As described above, according to the method of producing a liquid crystal display unit in this embodiment, since the second adhesive 31 composed of the light-curing resin is cured for a short time by irradiating the second adhesive layer 31 with light having a wavelength of 340 nm or more, each of the transparent substrates 30a and 30b can be easily adhesively bonded and fixed to the liquid crystal panel 20 for a short time.

In the related art production method, since a thermosetting resin or a room-temperature setting resin is used for adhesively bonding and fixing a transparent substrate to a liquid crystal panel, it takes several hours to cure the resin. On the contrary, according to this embodiment, since the light-curing resin is used for adhesively bonding and fixing a transparent substrate to a liquid crystal panel, it takes several seconds to cure the resin. As a result, according to this embodiment, it is possible to significantly improve the productivity of a liquid crystal display unit.

According to this embodiment, ultraviolet light having a wavelength of 340 nm or more is used as light for irradiating the second adhesive 32 so as to cure the second adhesive 32. In general, unlike short-wavelength ultraviolet light having a wavelength range of less than 320 nm, long-wavelength ultraviolet light having a wavelength range of 320 to 400 nm does not exert adverse effect on components of the liquid crystal panel 20 such as thin film transistors, liquid crystal molecules, and adhesive. Accordingly, with the use of ultraviolet light having a wavelength of 340 nm or more, which is within the above range (320 to 400 nm) of the long-wavelength ultraviolet light, it is possible to prevent the components of the liquid crystal panel 20 from being damaged at the time of irradiating the second adhesive 32 with the ultraviolet light for curing the second adhesive 32, and hence to prevent the display quality of the liquid crystal panel 20 from being degraded.

A further advantage of this embodiment is that since the second adhesive 31 is cured without any heating treatment, it is possible to eliminate occurrence of stress in the outer frame 10, the liquid crystal panel 20, and each of the transparent substrates 30a and 30b due to a difference in thermal expansion coefficient between two of the outer frame 10, the liquid crystal panel 20, and each of the transparent substrates 30a and 30b. This makes it possible to eliminate occurrence of the structural deformation of each of parts of the liquid crystal display unit, and hence to prevent a variation in gap of the liquid crystal layer.

In this embodiment, the second adhesive 31 is cured by irradiating the second adhesive 31 with light having a wavelength of 340 nm or more via the sharp cut filter 52 capable of shielding a light component having a wavelength less than 340 nm; however, the present invention is not limited thereto but may variously configured without departing from the scope of the present invention, that is, insofar as a light-curing resin used as the second adhesive 31 can be cured with light having a wavelength of 320 nm or more. More specifically, the present invention may be configured such that a light-curing resin used as the second adhesive 31 be cured with ultraviolet light while a short-wavelength ultraviolet light component having a wavelength of less than 320 nm, which is liable to give damages to components of the liquid crystal panel 20 such as thin film transistors, is shielded.

While the preferred embodiment of the present invention has been described using the specific terms, such description is for illustrative purposes only, and it is to be understood that changes and variations may be made without departing from the spirit or scope of the following claims.

What is claimed is:

1. A method of producing a liquid crystal display unit including a liquid crystal panel and a transparent substrate adhesively bonded and fixed to an outer surface of said liquid crystal panel, said method comprising the steps of:
bringing said transparent substrate in close-contact with said liquid crystal panel with a light-curing resin put therebetween;
irradiating said light-curing resin with light having a wavelength of 320 nm or more to cure said light-curing resin, thereby adhesively bonding and fixing said transparent substrate to said liquid crystal panel.

2. A method of producing a liquid crystal display unit according to claim 1, wherein said light-curing resin is irradiated with said light having a wavelength of 320 nm or more via a filter shielding a light component having a wavelength of less than 320 nm.

3. An apparatus of producing a liquid crystal display unit including a liquid crystal panel and a transparent substrate adhesively bonded and fixed to an outer surface of said liquid crystal panel, said apparatus comprising:
means for irradiating a light-curing resin interposed between said liquid crystal panel and said transparent substrate with light having a wavelength of 320 nm or more.
